(19) United States
(12) Patent Application Publication
(10) Pub. No.: US 2006/0168173 A1
(43) Pub. Date: Jul. 27, 2006

(54) Method and apparatus for conditional application of management commands

(75) Inventors: Alexander Clemm, Los Gatos, CA (US); Steven Berl, Piedmont, CA (US)

Correspondence Address: HAMILTON, BROOK, SMITH & REYNOLDS, P.C., 530 VIRGINIA ROAD, P.O. BOX 9133, CONCORD, MA, 01742-9133, US

(73) Assignee: Cisco Technology, Inc.

(21) Appl. No.: 11/013,964

(22) Filed: Dec. 15, 2004

(51) Int. Cl. G06F 15/173

(52) U.S. Cl. 709/223

(57) ABSTRACT

Device management commands are augmented with a condition that is evaluated prior to the command being executed at a managed device. If the condition is met, the command is executed; otherwise, execution of the command is rejected. An agent for operating a network device comprises a parser that receives from a network manager a conditional command communication that includes a condition and at least one management command. A preprocessor evaluates the condition. A command processor executes the management command if the condition is met, and transmits to the network manager a response indicative of management command execution status.

### BACKGROUND

Network management systems provide the capability to control and manage network devices that reside on a network. In a typical arrangement, a network management system includes a device interaction component that communicates with managed devices such as routers, gateways, access servers, switches, bridges, hubs, printers or other network devices, across the network. Each managed device includes a software application called an agent. The agent provides an abstraction of the managed device that it represents, usually termed a Management Information Base. A part of the Management Information Base refers to configuration information, stored in a Configuration Database on the device. The agent collects and stores management information and makes the information available to the network management system using a network management protocol such as the well-known Simple Network Management Protocol (SNMP) and Common Management Information Protocol (CMIP), or using a Command Line Interface (CLI).

The device interaction component may be used by a management application to communicate with the managed devices for the functions of performance management, configuration management, accounting management, fault management and security management. Performance management relates to measuring network performance for variables such as network throughput, user response times, and resource utilization. Configuration management is concerned with provisioning devices in the network and changing and retrieving network and system configuration information. Accounting management measures network-utilization parameters in order to regulate access by individual and groups of users on the network. Fault management relates to detection and correction of network problems. Security management deals with controlling access to network resources based on appropriate user authorizations.

One problem in network management concerns accidental misconfiguration of network devices based on mistaken assumptions about the current state of the devices. For example, it may happen that a software application applies a command to reconfigure a device based on a certain assumption, that would not have been applied had the application known the assumption to be mistaken. Specific examples of such misconfiguration include: different applications independently altering the configuration of a device, without the applications being aware of it; different software packages installed on the device than expected; different operating system versions on the device. These misconfigurations can result in unexpected response codes that are difficult to explain, or may lead to unanticipated and unintended system behavior that can be hard to troubleshoot.

A technique that is commonly used by management applications to protect against accidental application of management commands under false assumptions as to the current condition or state of the device is to check for certain conditions of a device before proceeding to apply a command. However, such condition checking occurs at the application side and not at the device, using the knowledge that the application has about the device, which may or may not be accurate. That approach requires additional iterations of request and response between the application and the device, which may impact performance, scale and implementation effort. In addition, such an approach does not protect the device against ill-behaved applications.

### BRIEF DESCRIPTION OF THE DRAWINGS

To provide a more complete understanding of the present invention and features and advantages thereof, reference is made to the following description, taken in conjunction with the accompanying drawings, wherein like reference numerals represent like parts. The drawings are not necessarily to scale, emphasis instead being placed upon illustrating the principles of the invention.

FIG. 1 is a block diagram of a network configuration that illustrates principles of the present approach.

FIG. 2 is a block diagram of an agent of FIG. 1.

FIG. 3 is a flow diagram that illustrates a process flow for the agent of FIG. 2.

FIG. 4 is a diagram that illustrates one type of communication between an agent and a manager without the benefit of the present approach.

FIG. 5 is a diagram that illustrates one type of communication between an agent and a manager with the benefit of the present approach.

FIG. 6 is a diagram that illustrates a second type of communication between an agent and a manager without the benefit of the present approach.

FIG. 7 is a diagram that illustrates a second type of communication between an agent and a manager with the benefit of the present approach.

### DETAILED DESCRIPTION

The present approach is directed to a mechanism that provides for conditional execution of management commands at a device. Device management commands are augmented with a condition that is evaluated prior to the command being executed. If the condition is met, the command is executed; otherwise, execution of the command is rejected.

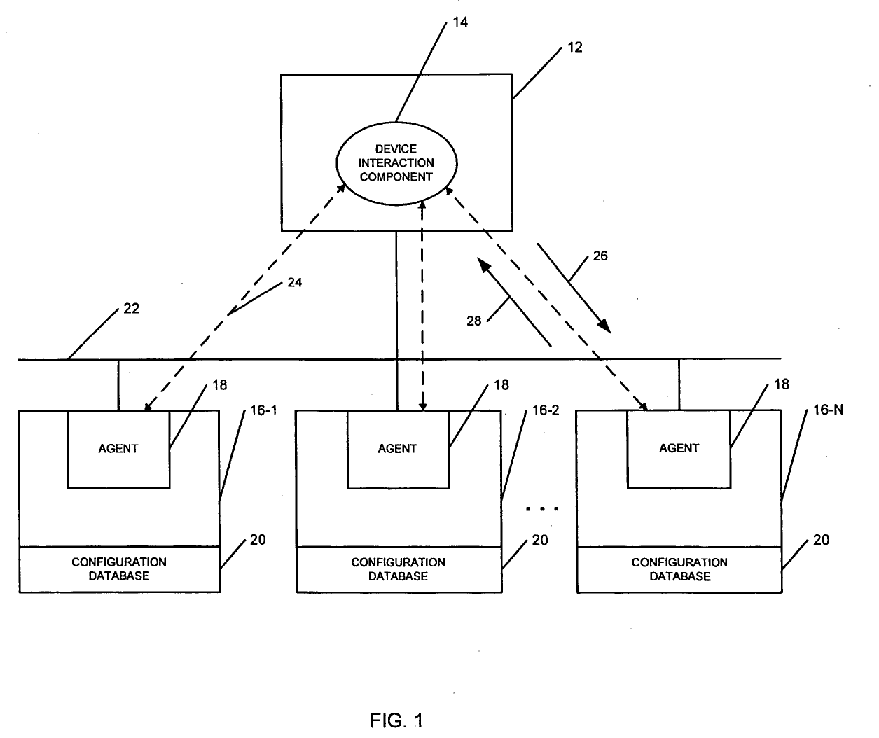

Referring to FIG. 1, a network configuration illustrates principles of the present approach. The network configuration includes a network management system (NMS) 12 and managed network devices 16-1, . . . , 16-N coupled to network 22. The managed network devices may include, for example, routers, gateways, access servers, switches, bridges, hubs, printers or other network devices. The managed network devices each include an agent 18 and a configuration database 20. The agent 18 collects and stores management information in the configuration database 20 and makes the information available to the NMS 12 using network management protocol 24.

The NMS 12 includes a device interaction component 14 that communicates with the agents 18 using communications protocol 24. With the present approach as described further herein, a conditional command 26 is sent to a particular agent, and the agent returns a response 28.

One possible approach for a conditional command mechanism is to simply add an additional parameter to a management command, a command condition. However, that approach is impractical, as it would require changing existing management commands. Rather, to avoid having to change existing management commands, the preferred approach is to provide a “condition command” that wraps the management command that is to be executed. In effect, the condition command carries the management command that is to be executed as a parameter.

In an embodiment, the conditional command has the following format:

Conditional-command <condition><management command>+end

where <condition> may include a condition variable, a comparator and a target value; <management command> corresponds to one or more (e.g., a group) regular management type commands that a network management system may apply to a managed device; and “end” is the closing bracket. As an example, the condition variable may correspond to a configuration version of the network device (e.g., “configuration version=3544”) or a version of a particular software application or operating system running on the device (e.g., “IOS version=12.2T”). Other variables may include, for example, hardware platform type and software image feature set. The condition may comprise two or more conditions combined using Boolean logic operators, e.g., <condition 1 AND condition 2>.

The management command may be, for example, command line interface commands or programmatic management interface commands that may describe a desired device configuration. The management commands can also be “exec” type commands that command the device to perform some type of action.

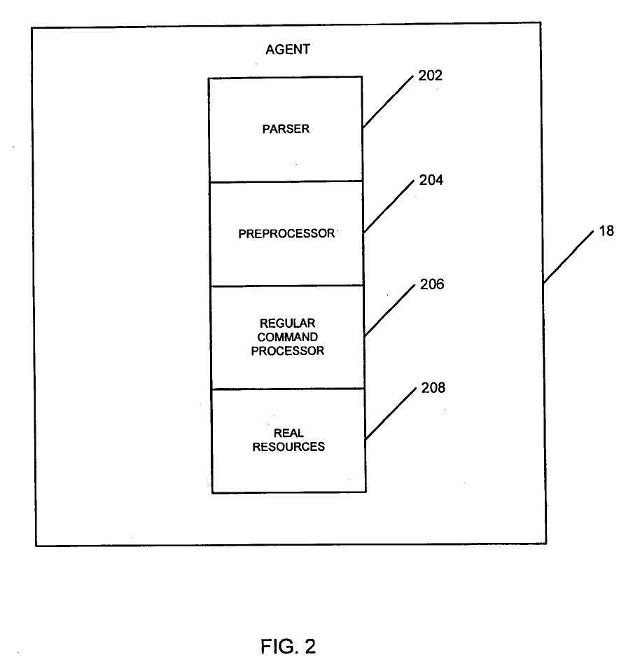

FIG. 2 illustrates an embodiment of the agent 18 of FIG. 1. The agent 18 includes a parser 202, a preprocessor 204, regular command processor 206, and real resources 208. Upon receipt of a command from a manager 14 (FIG. 1), the parser 202 identifies the command as a conditional command and passes it to the preprocessor 204. The preprocessor 204 may, if a locking mechanism is available, lock (implicitly or explicitly) the device 16 (FIG. 1) against other management commands by 3^{rd} parties and evaluate the condition. If the condition is not met, execution of the management command is rejected, the device is unlocked and a response 28 (FIG. 1) is sent to the manager 14. A “condition violation” response indicates the command was not executed if the condition is not met. An “invalid condition” response indicates the command was not executed if the condition cannot be validated.

If the condition is met, the management command is passed to the regular command processor 206 for execution. The command processor 206 may utilize real resources (such as, functions of the operating system of the device) 208 to implement the function or feature corresponding to the management command. Upon return from regular processing of the management command, the device is unlocked and a response 28 (FIG. 1) is sent to the manager 14. The transmitted response may be a “command response” indicating a particular response to the executed command if the condition is met.

As can be understood, the evaluation of the condition provided by the present approach helps to avoid performing actions that may be disruptive to the network.

It should be understood that a locking mechanism may or may not be available at the managed device. If a locking mechanism is available, the device can be locked during evaluation of the condition and execution of the command in order to ensure that the condition does not change between evaluation and command execution. However, even in the absence of a locking mechanism, the condition evaluation increases confidence of network management operations.

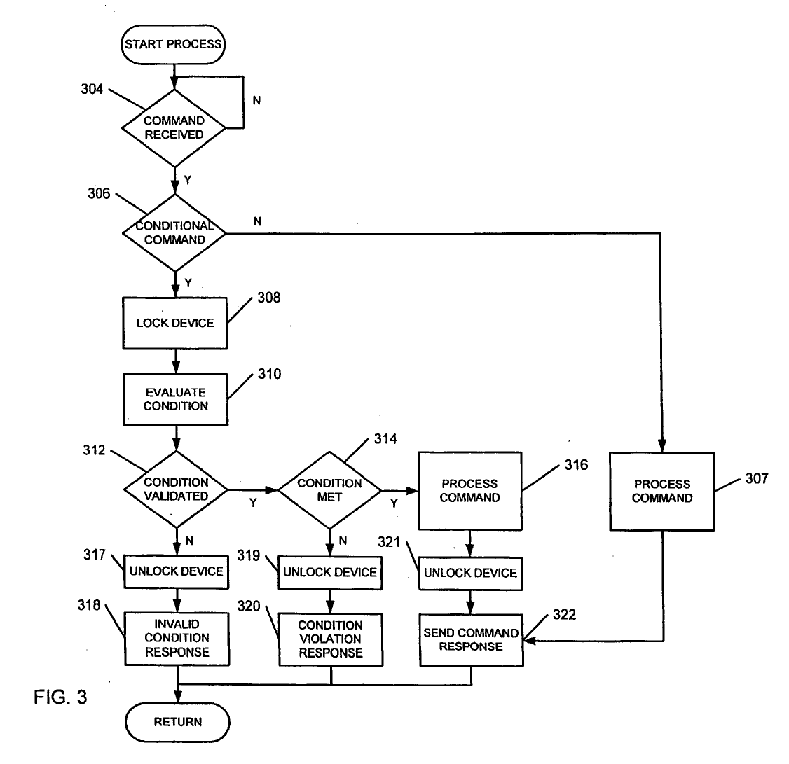

FIG. 3 is a flow diagram illustrating a process flow for the agent 18 (FIG. 2). At the start of the process, if a command is received at 304 and determined to be a conditional command at 306, then the device is locked at 308; otherwise, regular command processing continues at 307 and transmission of a command response at 322. At 310, the condition is evaluated. If the condition cannot be validated at 312, then processing continues at 317 with unlocking of the device and transmission of an invalid condition response to the manager 14 (FIG. 1) at 318. If the condition can be validated at 312 then processing continues at 314 with a check to determine whether condition is met. If the condition is not met, then processing continues at 319 with unlocking of the device and transmission of a condition violation response at 320. If the condition is met at 314, then processing continues at 316 with processing of the management command, followed by unlocking of the device at 321 and transmission of a command response at 322.

Two examples of configuration communications are now described to illustrate the advantages of the present approach.

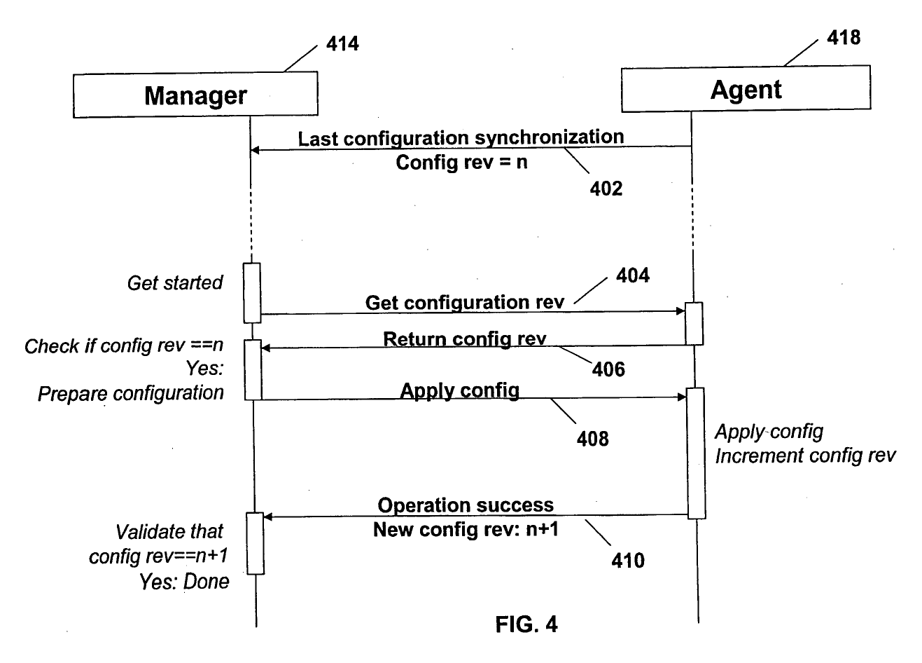

FIG. 4 illustrates one type of communication between an agent and a manager without the benefit of the present approach. In this scenario, an agent 418 has previously sent a response 402 to a manager 414 that indicates the configuration revision of the managed device is rev=n. At the start of a later communication, the manager sends a “get configuration rev” command 404 to the agent. In reply, the agent sends a “return config rev” response 406. The manager 414 then checks if the configuration revision is the same as the last known value, namely, rev=n. Upon this confirmation of the configuration revision, the manager sends an “apply config” command 408 to the agent. The agent applies the new configuration and increments the configuration revision value to rev=n+1. The agent sends to the manager a response 410 that indicates successful operation of the reconfiguration command and indicates the configuration revision value is rev=n+1. The manager then must validate that the configuration value is indeed now rev=n+1 and the communication is complete. Note that this communication scenario requires a get/return communication to check the configuration value prior to sending the command that actually applies the new configuration.

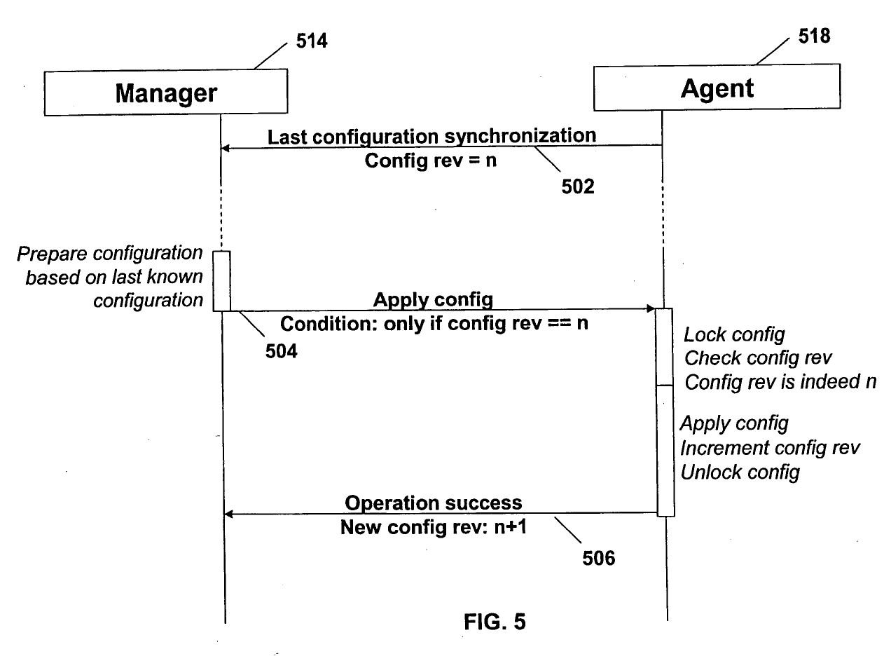

FIG. 5 shows improved communication for the scenario of FIG. 4 based on the benefit of the present approach. In particular, manager 514 does not need to use a get/return communication prior to requesting a reconfiguration. Rather, based on the last known configuration (rev=n) communicated at 502, the manager sends a conditional command 504 that includes the management command “apply config” with the condition: “only if config rev==n”. The agent 518, upon receipt of conditional command 504, locks the configuration, determines whether the configuration revision is indeed equal to “n”, applies the new configuration, increments “config rev=n+1”, and unlocks the configuration. The agent completes the communication with a response 506 that indicates successful command operation and indicates the configuration revision value is rev=n+1. Note that this scenario requires fewer messages (only a conditional command and response) than that shown in FIG. 4, resulting in improved performance.

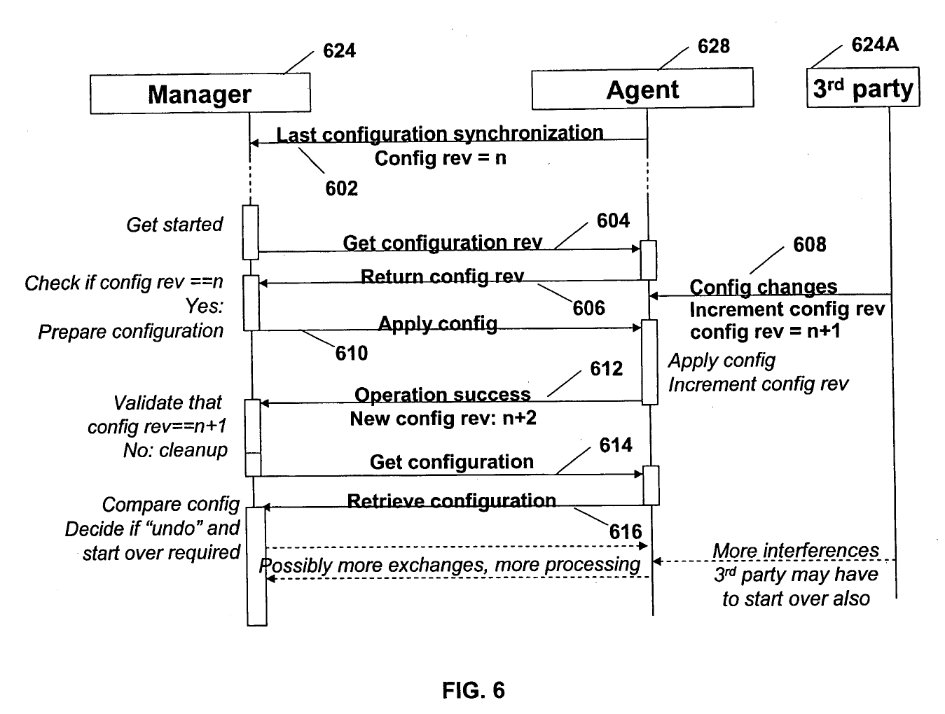

FIG. 6 is a diagram that illustrates a second type of communication between an agent 628 and a manager 624 without the benefit of the present approach. In this communications scenario, the communications 602, 604 and 606 are similar to the communications 402, 404 and 406 described above (FIG. 4) for initially checking if the configuration revision is as expected, i.e., rev=n. However, subsequent to the “return config rev” response 606, a 3^{rd} party manager or other entity 624A may happen to apply a configuration change 608 to the agent 628, resulting in the configuration revision being incremented such that config rev=n+1 for the managed device corresponding to agent 628. This action by entity 624A is likely done independent of, and unbeknownst to, manager 624. A subsequent “apply config” management command 610 by manager 624 results in the agent 628 applying the configuration, with a response 612 to the manager 624 indicating operation success and reporting the new config rev=n+2. The manager 624 at this point would have been expecting confirmation that config rev=n+1. Subsequently, manager 624 and the agent 628 may need to communicate configuration information via get/return 614, 616 messages, simply to compare configurations and decide if an “undo” and start over is required. It is possible that additional 3^{rd} party interferences may occur, with uncertain and unexpected results.

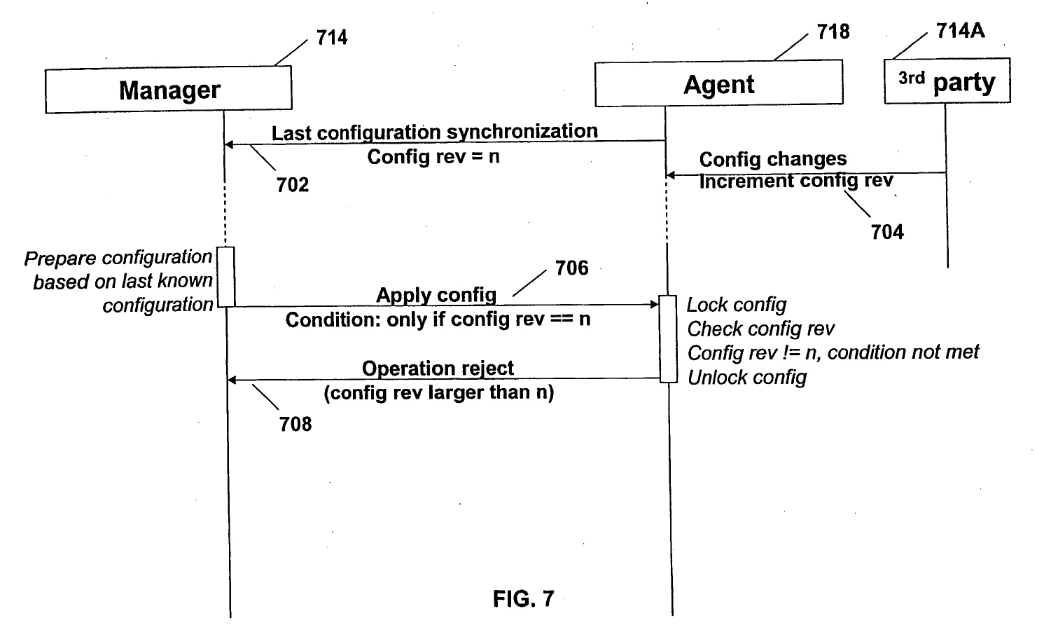

FIG. 7 illustrates much improved communication for the scenario of FIG. 6 based on the present approach. In this scenario, subsequent to an agent 718 having sent a response 702 to a manager 714 that indicates the configuration revision of the managed device is rev=n, a 3^{rd} party manager or other entity 714A independently may apply a configuration change 704 to the agent 718 that results in the configuration revision of the managed device being incremented, i.e., rev=n+1. Subsequently, the manager 714 may prepare to apply a configuration to the agent 718 based on the last known configuration, i.e., rev=n. However, rather than simply send an “apply config” management command, the manager 714 sends a conditional command 706 in accordance with the present approach. The conditional command includes the management command “apply config” with the condition: “only if config rev==n”. The agent 718, upon receipt of conditional command 706, locks the configuration and determines that the configuration revision is not equal to “n”, i.e., the condition is not met. The agent unlocks the device and completes the communication with a response 708 that indicates rejection of the command operation with information that the configuration revision value is larger than n. Note that this scenario requires fewer messages (only a conditional command and response) than that shown in FIG. 6, resulting in improved performance and does not require that the manager “undo” any actions.

While this invention has been particularly shown and described with references to preferred embodiments thereof, it will be understood by those skilled in the art that various changes in form and details may be made therein without departing from the scope of the invention encompassed by the appended claims.

What is claimed is:

1. A method of operating a network device, the method comprising:
receiving a conditional command communication that includes a condition and at least one management command;
evaluating the condition;
executing the at least one management command if the condition is met;
transmitting a response indicative of management command execution status.

2. The method of claim 1, wherein transmitting a response includes transmitting a command response indicating a particular response to the executed command if the condition is met.

3. The method of claim 1, wherein transmitting a response includes transmitting a condition violation response indicating the command was not executed because the condition is not met.

4. The method of claim 1, wherein transmitting a response includes transmitting an invalid condition response indicating the command was not executed because the condition cannot be validated.

5. The method of claim 1, wherein the conditional command is received from a network management system via a programmatic management interface.

6. The method of claim 1, wherein the conditional command is received from a user via a command line interface.

7. The method of claim 1, further comprising locking the network device during evaluation of the condition and before transmission of the response.

8. The method of claim 1, wherein the condition includes a condition variable, a comparator and a target value.

9. The method of claim 8, wherein the condition variable comprises a configuration version of the network device.

10. The method of claim 8, wherein the condition variable comprises a version of a software application running on the network device.

11. The method of claim 8, wherein the condition variable comprises a version of an operating system running on the network device.

12. The method of claim 8, wherein the condition variable comprises a hardware platform type.

13. The method of claim 8, wherein the condition variable comprises a software image feature set.

14. The method of claim 1, wherein the condition comprises two or more conditions combined using Boolean logic.

15. An agent for operating a network device managed by a network manager across a network, the agent comprising:
a parser for receiving from the network manager a conditional command communication that includes a condition and at least one management command;
a preprocessor for evaluating the condition;
a command processor for executing the at least one management command if the condition is met and for transmitting to the network manager a response indicative of management command execution status.

16. The agent of claim 15, wherein the command processor transmits a command response indicating a particular response to the executed command if the condition is met.

17. The agent of claim 15, wherein the command processor transmits a condition violation response indicating the command was not executed if the condition is not met and an invalid condition response indicating the command was not executed if the condition cannot be validated.

18. The agent of claim 15, wherein the conditional command is received from a programmatic management interface or a command line interface.

19. The agent of claim 15, wherein the preprocessor locks the network device during evaluation of the condition and before transmission of the response.

20. The agent of claim 15, wherein the condition includes a condition variable, a comparator and a target value.

21. The agent of claim 20, wherein the condition variable comprises a configuration version of the network device.

22. The agent of claim 20, wherein the condition variable comprises a version of a software application or an operating system running on the network device.

23. The agent of claim 20, wherein the condition variable comprises a hardware platform type.

24. The agent of claim 20, wherein the condition variable comprises a software image feature set.

25. The agent of claim 15, wherein the condition comprises at least two conditions combined using Boolean logic.

26. Apparatus for operating a network device, the apparatus comprising:
means for receiving a conditional command communication that includes a condition and at least one management command;
means for evaluating the condition;
means for executing the at least one management command if the condition is met;
means for transmitting a response indicative of management command execution status.

27. An article of manufacture comprising a computer usable medium having computer readable program code means embodied therein for:
receiving a conditional command communication that includes a condition and at least one management command;
evaluating the condition;
executing the at least one management command if the condition is met;
transmitting a response indicative of management command execution status.
